(19) United States
(12) Patent Application Publication
(10) Pub. No.: US 2026/0204497 A1
(43) Pub. Date: Jul. 16, 2026

(54) BUTTON APPARATUS AND ELECTRONIC EQUIPMENT

(71) Applicant: CASIO COMPUTER CO., LTD., Tokyo (JP)

(72) Inventor: Otoya SAKAI, Machida-shi (JP)

(73) Assignee: CASIO COMPUTER CO., LTD., Tokyo (JP)

(21) Appl. No.: 19/563,524

(22) Filed: Mar. 11, 2026

Related U.S. Application Data
(63) Continuation of application No. 18/327,485, filed on Jun. 1, 2023, now Pat. No. 12,597,571.

(30) Foreign Application Priority Data
Jun. 1, 2022 (JP) 2022-089480

(51) Int. Cl. H01H 13/14; G10H 1/34; H01H 13/02

(52) U.S. Cl. CPC H01H 13/14; G10H 1/34; H01H 13/023

(57) ABSTRACT

A button apparatus comprises a push member on which a push operation can be performed, an elastic member of a substantially hollowed shape provided on a push direction side of the push member and configured to be elastically deformed on a side thereof which faces the push member in response to the push operation performed on the push member, a detector configured to detect the push operation performed on the push member, and a moving member supported on the elastic member and configured to move in the push direction in response to the push operation performed on the push member, and a side of the elastic member which faces the detector is elastically deformed as a result of the moving member moving in response to the push operation.

### CROSS-REFERENCE TO RELATED APPLICATION

This patent application is a continuation application of US Patent Application No. 18/327,485 filed on 06/01/2023 which is based upon and claims the benefit of priority under 35 USC 119 of Japanese Patent Application No. 2022-089480 filed on June 1, 2022, the entire disclosure of which, including the specification, claims, drawings and abstract, is incorporated herein by reference in its entirety.

### BACKGROUND

### TECHNICAL FIELD

The present disclosure relates to a button apparatus and electronic equipment.

### Description of the Related

There have conventionally been known button apparatuses equipped on electronic equipment such as an electronic piano or the like for enabling various settings. In button apparatuses of this type, there have been proposed some button apparatuses which include an elastic member such as a rubber member so as to improve a clicking feel sensed by a user when he or she pushes down the button apparatus. For example, Japanese Unexamined Patent Application Publication No. 2020-155317 (JP-A-2020-155317) discloses a push-button switch including a front case, a movable contact sheet, a push button, a key guide, and a click rubber which is an elastic member.

In this push-button switch, the click rubber is provided at a lower portion of the push button, and when the push button is pushed down by a user, a part of the push button pushes the click rubber downwards while being guided by the key guide, and eventually, the click rubber pushes the movable contact sheet downwards.

### SUMMARY

According to an aspect of the present disclosure, there is provided a button apparatus comprising a push member on which a push operation can be performed, an elastic member of a substantially hollowed shape provided on a push direction side of the push member and configured to be elastically deformed on a side thereof which faces the push member in response to the push operation performed on the push member, a detector configured to detect the push operation performed on the push member, and a moving member supported on the elastic member and configured to move in the push direction in response to the push operation performed on the push member, and a side of the elastic member which faces the detector is elastically deformed as a result of the moving member moving in response to the push operation.

According to another aspect of the present disclosure, there is provided electronic equipment including the button apparatus.

### BRIEF DESCRIPTION OF THE DRAWINGS

FIG. 1 is an overall perspective view of a keyboard instrument according to an embodiment of the present disclosure;

FIG. 2 is a perspective view of a left case of the electronic keyboard instrument according to the embodiment as viewed from a right side;

FIG. 3 is a sectional view in a front-rear direction of a button group of the electronic keyboard instrument according to the embodiment, taken along a line III-III in FIG. 2;

FIG. 4 is an exploded perspective view of the button group of the electronic keyboard instrument according to the embodiment;

FIG. 5A is a perspective view of a key guide of a decision button according to the embodiment, resulting when the key guide is seen obliquely from above;

FIG. 5B is a perspective view of the key guide of the decision button according to the embodiment, resulting when the key guide is seen obliquely from below;

FIG. 6A is a perspective view of a rubber key of the decision button according to the embodiment, resulting when the rubber key is seen obliquely from above;

FIG. 6B is a perspective view of the rubber key of the decision button according to the embodiment, resulting when the rubber key is seen obliquely from below;

FIG. 7 is a sectional view in a left-right direction of the decision key according to the embodiment;

FIG. 8 is a sectional view in the front-rear direction of the decision key according to the embodiment;

FIG. 9 is a sectional view in the front-rear direction of the decision key according to the embodiment showing a state in which a key top is pushed down halfway, in which E1 is an enlarged sectional view showing a circumference of a rubber-side projecting portion and a guide-side projecting portion, and E2 is an enlarged sectional view showing a circumference of a hinge portion;

FIG. 10 is a sectional view in the front-rear direction of the decision key according to the embodiment showing a state in which the key top is pushed down to a lower limit position, in which E3 is an enlarged sectional view showing the circumference of the rubber-side projecting portion and the guide-side projecting portion, and E4 is an enlarged sectional view showing the circumference of the hinge portion;

FIG. 11A is a sectional view in the front-rear direction of a circumference of the key top of the decision button according to the embodiment showing a state in which the key top stays in a normal position;

FIG. 11B is a sectional view in the front-rear direction of the circumference of the key top of the decision button according to the embodiment showing a state in which the key top deviates in position in the front-rear direction; and

FIG. 12 is a perspective view of the button group of the electronic keyboard instrument according to the embodiment showing a light guiding form in which light from light emitting diodes (LEDs) in the decision button is guided.

### DESCRIPTION OF THE EMBODIMENT

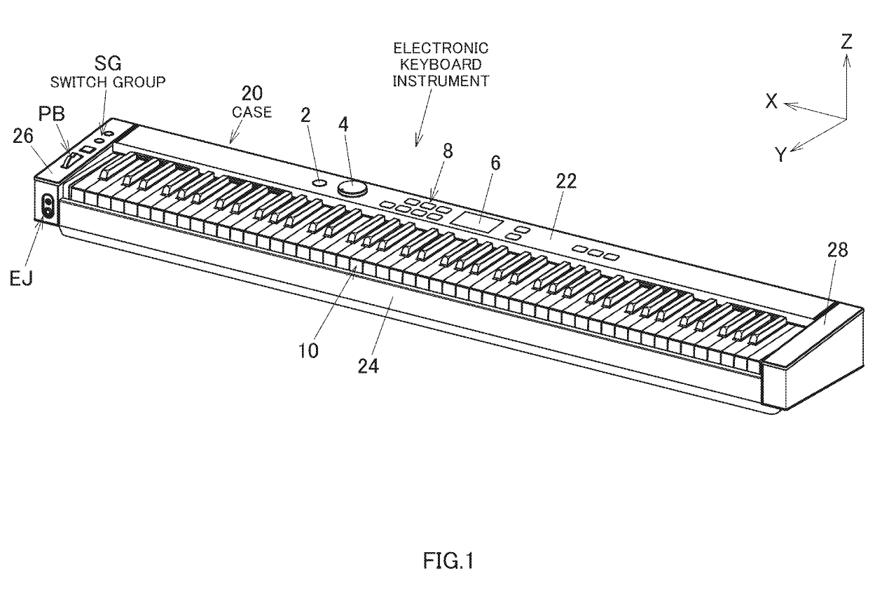

Referring to drawings, an embodiment of the present disclosure will be described below. An electronic keyboard instrument (electronic equipment) 1 shown in FIG. 1 includes a keyboard unit 10 including plural white keys and plural black keys, and a case 20. A control circuit board, not shown, and the like are accommodated in an interior of the case 20. Coordinate axes are shown in each accompanying drawing. Hereinafter, the embodiment will be described based on the understanding that in each accompanying drawing, an X-axis direction is referred to as a left-right direction of the electronic keyboard instrument 1 (a key alignment direction in the keyboard unit 10) (an X-axis positive direction is referred to as a left direction), a Y-axis direction is referred to as a front-rear direction of the electronic keyboard instrument 1 (a direction in which each key extends in the keyboard unit 10) (a Y-axis positive direction is referred to as a front direction), and a Z-axis direction is referred to as an up-down direction of the electronic keyboard instrument 1 (a Z-axis positive direction is referred to as an up direction).

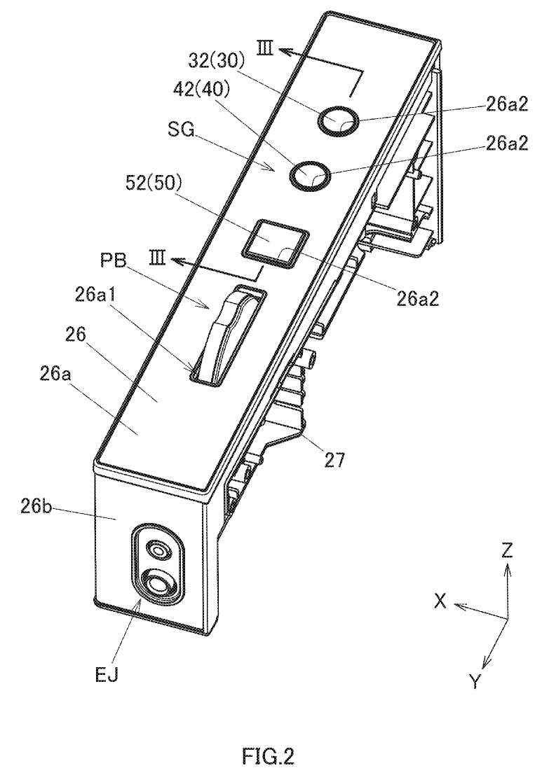

The case 20 has substantially a horizontally long rectangular plate shape in which a longitudinal direction follows the left-right direction and is made from a synthetic resin. The case 20 is divided into an upper case 22, a lower case 24, a left case 26, and a right case 28. A power supply button 2 for switching on and off a power supply to the electronic keyboard instrument 1, a volume knob 4 for controlling the volume of sound produced in the electronic keyboard instrument 1, a liquid crystal display portion 6, and a control panel portion 8 are provided on an upper surface of the upper case 22. As shown in FIG. 2, the left case 26 has an upper panel 26a which makes up an upper surface thereof and which is formed from an acrylic resin and a case side wall 26b which makes up a side wall of the left case 26. A control opening portion 26a1 is provided in a front portion the upper panel 26a so that a part of a pitch bender PB, which is configured to control the pitch of a note by bending or changing smoothly the pitch of the note, is exposed therefrom. Setting opening portions 26a2 are provided in a rear portion of the upper panel 26a so that parts (upper surfaces of key tops 32, 42, 52, which will be described later) of a button group SG, which is configured to make various settings, are exposed therefrom. In addition, an earphone jack EJ is provided in a front surface of the case side wall 26b.

The button groove SG has three buttons (button apparatuses) 30, 40, 50, which are disposed at substantially equal intervals in the front-rear direction and are configured to be pushed down in a Z-axis negative direction (a push direction). These three buttons 30, 40, 50 are referred to sequentially as a first setting button 30, a second setting button 40, and a decision button 50 as viewed from a rear side of the upper panel 26a. The first setting button 30 is a button for switching on and off, for example, a function of automatically play a broken chord in the electronic keyboard instrument 1. The second setting button 40 is a button for providing, for example, a function of a smartphone application. The decision button 50 is a button to which, for example, a modulation effect and other functions of the electronic keyboard instrument 1 are assigned. Various functions other than those described above can also be assigned to the individual buttons 30, 40, 50. In other words, the electronic keyboard instrument 1 (the electronic equipment) excluding the button apparatuses 30, 40, 50 constitutes an electronic equipment main body which is operated by the button apparatuses 30, 40, 50.

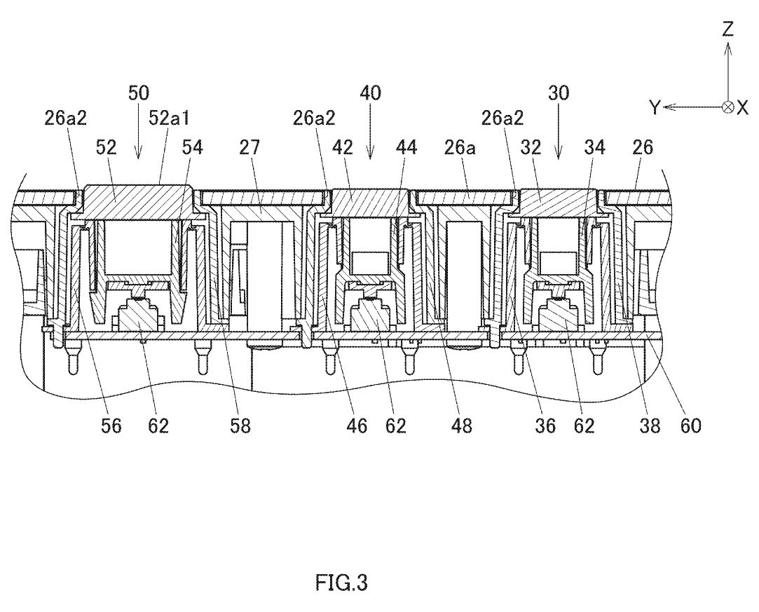

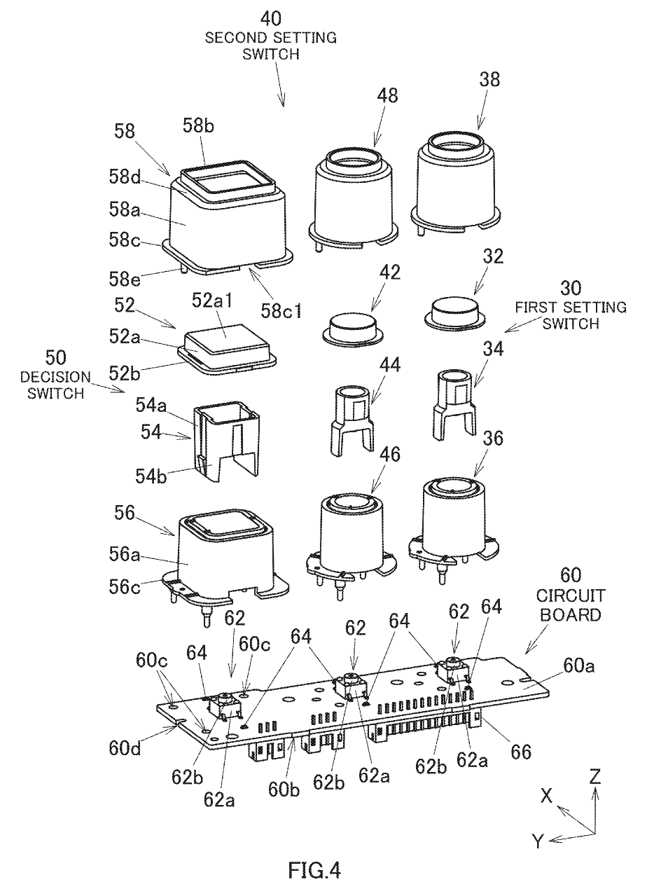

An inner frame 27, which is a member of a frame shape, is provided on an inner surface side of the left case 26. Individual members making up the pitch bender PB, individual members making up the button group SG, and the like are accommodated inside the inner frame 27. As shown in FIGS. 3 and 4, a circuit board 60 is provided inside the inner frame 27 in a position lying underneath the button group SG. Button units (detectors) 62 and pairs of light emitting diodes (LEDs) (light sources) 64 are provided individually in positions corresponding to the buttons 30, 40, 50 in the up-down direction on an upper surface 60a of the circuit board 60. The button units 62 are configured to be pushed down to switch on and off the individual functions of the buttons 30, 40, 50. Each of the pairs of LEDs 64 is provided for each button unit 62 with a light emitting side oriented upwards. That is, one button unit 62 and a pair of LEDs 64 are provided individually at a rear side or portion, a substantially central portion in the front-rear direction, and a front side or portion of the circuit board 60. Contact terminals 66, which are electrically connected with individual equipment inside the case 20, are provided on a lower surface 60b of the circuit board 60.

The button units 62 provided on the upper surface 60a of the circuit board 60 each have a fixed contact module 62a of a substantially rectangular parallelepiped shape and a moving contact module 60b of a substantially circular cylindrical shape. The fixed contact module 62a is fixed to the circuit board 60 and is electrically connected with connection wiring on the circuit board 60. The moving contact module 60b is provided on the fixed contact module 62a and is configured to move relatively to the fixed contact module 62a in the up-down direction. When the moving contact modules 62b are pushed down to move downwards by the corresponding buttons 30, 40, 50, contact terminals inside the moving contact modules 62b are brought into abutment with contact terminals inside the fixed contact modules 62a so as to switch on and off the individual functions of the buttons 30, 40, 50.

The first setting button 30, the second setting button 40, and the decision button 50, which make up the button group SG, have the same mechanical configuration and are different only in external shape from one another. Specifically speaking, the first setting button 30 and the second setting button 40 each have a substantially circular cylindrical external shape as a whole, and portions thereof which are configured to be pushed down by a user each have a circular shape. The decision button 50 has a substantially angular cylindrical external shape, and a portion thereof which is configured to be pushed down by the user has a substantially square shape (refer to FIG. 4 and the like). The individual buttons 30, 40, 50 include, respectively, key tops (push members) 32, 42, 52 each having a surface configured to be pushed down by the user, key guides (moving members) 34, 44, 54 which are provided underneath the corresponding key tops 32, 52, 52, rubber keys 36, 46, 56 which are rubber members, and light guides (light guiding members) 38, 48, 58 for guiding light from the LEDs 64 towards the key tops 32, 42, 52.

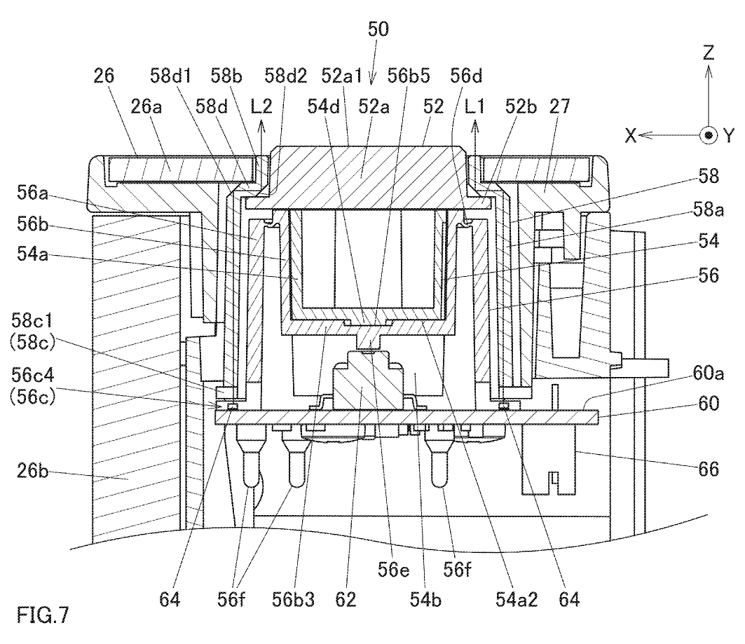

Hereinafter, in the buttons 30, 40, 50 making up the button group SG and having the same mechanical configuration, the configuration (excluding the circuit board 60 and the LEDs 64) of the decision button 50 will be described in detail. As shown in FIGS. 4, 7, and the like, the key top 52 of the decision button 50 is a thick member of a substantially square plate shape and is formed from, for example, a transparent acrylic resin. The key top 52 has a square plate portion 52a of a substantially square plate shape and a first protruding portion (a protruding portion) 52b which protrudes outwards from an edge portion of a lower surface of the square plate portion 52a as in the form of a collar. An upper surface (hereinafter, referred to as a “push surface 52a1”) of the square plate portion 52a is formed into a substantially square flat surface. The first protruding portion 52b protrudes outwards of the push surface 52a1.

The push surface 52a1 is exposed from the setting opening portion 26a2 in the left case 26 and then constitutes a surface on which the user performs a push operation. When the push surface 52a1 is in such a state that no push operation is performed thereon (hereinafter, referred to as a “normal state”), the push surface 52a1 is positioned slightly upwards (for example, 0.2 mm upwards) of the upper panel 26a of the left case 26. As shown in FIG. 3, the square plate portion 52a is formed thicker than the upper panel 26a, and the first protruding portion 52b is positioned underneath the upper panel 26a. For example, a black printing is applied to a lower surface of the key top 52, whereby a construction below the key top 52 is prevented from being seen through the push surface 52a1.

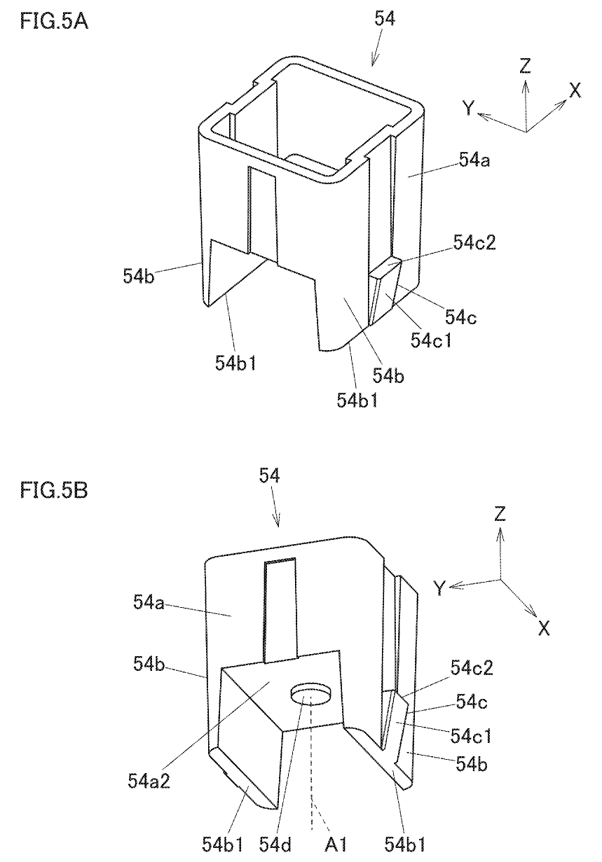

As shown in FIGS. 5A and 5B, the key guide 54 of the decision button 50 is a member of a substantially angular cylindrical shape and is formed from, for example, a high-impact polystyrene (HIPS) resin. The key guide 54 has a first box-shaped portion 54a which is opened upwards and plate-shaped projecting portions 54b which each project downwards substantially into a plate shape from both front and rear sides of a lower surface 54a2 of the first box-shaped portion 54a. Four corners of the first box-shaped portion 54a are each formed into an angularly rounded shape. The plate-shaped projecting portions 54b are each provided in such a posture that both plate surfaces thereof are oriented so as to follow the front-rear direction and have the same projecting dimension by which the plate-shaped projecting portions 54b extend downwards from the first box-shaped portion 54a. A distal end of each plate-shaped projecting portion 54b (a lower end of the key guide 54) is formed into a flat surface, which is then made into an abutment portion 54b1 configured to be brought into abutment with the upper surface 60a of the circuit board 60 as a result of a push operation being performed on the push surface 52a1 of the key top 52.

In addition, a dislocation prevention portion 54c for preventing a dislocation of the key guide 54 from the rubber key 56, which will be described later, is provided at a substantially central portion in the left-right direction on an outer surface of each plate-shaped projecting portion 54b. Each dislocation prevention portion 54c has an inclined surface 54c1 which is caused to incline upwards from the abutment portion 54b1. An upper end surface of each dislocation prevention portion 54c is provided flat from an upper end of the inclined surface 54c1 to the outer surface of the plate-shaped projecting portion 54b so as to be made into a dislocation prevention surface 54c2, which is configured to be brought into abutment with the rubber key 56 to thereby prevent a dislocation of the key guide 54 therefrom. Additionally, a guide-side projecting portion (a second pressing projecting portion) 54d is provided at a substantially central portion of the lower surface 54a2 of the first box-shaped portion 54a in such a manner as to project downwards into a substantially circular cylindrical shape. That is, the guide-side projecting portion 54d is provided on a pushing axis A1 of the key guide 54. The pushing axis A1 is along with the Z-axis and passes through a center of the key guide 54 in the X-Y plane. The guide-side projecting portion 54d presses on a part of the rubber key 56 as a result of a push operation being performed on the push surface 52a1 of the key top 52.

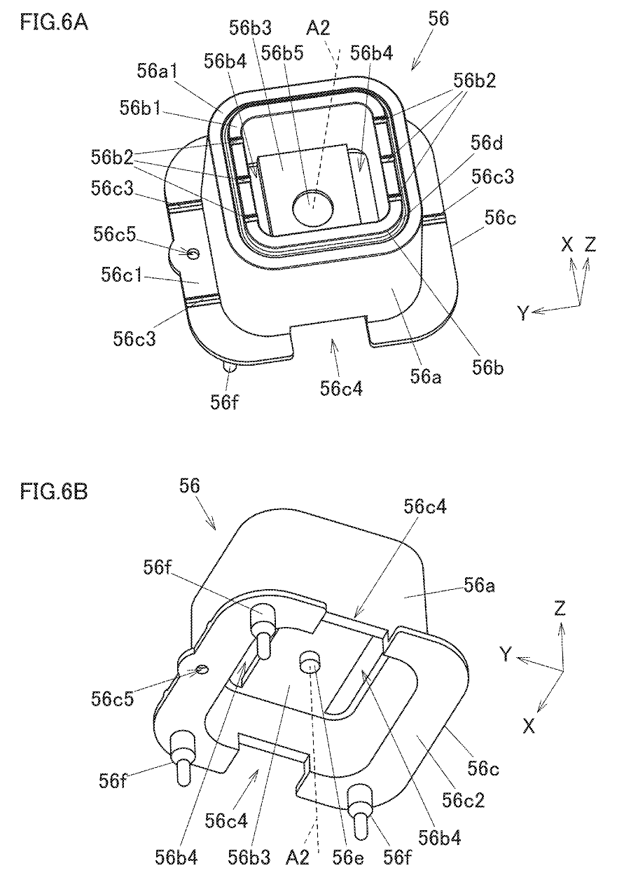

As shown in FIGS. 6A to 8, the rubber key 56 of the decision button 50 is an elastic member of a substantially angular cylindrical shape (hollowed shape) and is formed from, for example, a silicone rubber. The rubber key 56 has a first angular cylindrical portion (a fixed portion) 56a of a substantially angular cylindrical shape, a second box-shaped portion (a support portion) 56b of a substantially angular cylindrical shape, which is provided inside the first angular cylindrical portion 56a and is opened upwards, and a second protruding portion 56c, which protrudes outwards from a lower edge portion of the first angular cylindrical portion 56a into the form of a collar. Four corners of each of the first angular cylindrical portion 56a and the second box-shaped portion 56b are each formed into an angularly rounded shape. The second box-shaped portion 56b is connected with an upper end portion 56a1 of the first angular cylindrical portion 56a by a hinge portion (a connecting portion) 56d which extends from a position situated slightly downwards of an upper end portion 56b1 of the second box-shaped portion 56b.

The hinge portion 56d is provided in such a manner as to extend along a full circumference of an upper end of the first angular cylindrical portion 56a. As a result, in a plan view of the rubber key 56, a space defined between the first angular cylindrical portion 56a and the second box-shaped portion 56b is filled with the hinge portion 56d without any gap therebetween. The hinge portion 56d is made very much thinner than the first angular cylindrical portion 56a and the second box-shaped portion 56b, as a result of which the second box-shaped portion 56 is permitted to move in the up-down direction relative to the first angular cylindrical portion 56a due to an elastic deformation of the hinge portion 56d. In the normal state, the upper end portion 56b1 of the second box-shaped portion 56b is positioned upwards of the upper end portion 56a1 of the first angular cylindrical portion 56a, and the hinge portion 56d between the first angular cylindrical portion 56a and the second box-shaped portion 56b is made to stay in a downwardly recessed state.

As shown in FIG. 6A, six minute first projections (projecting portions) 56b2, which each project upwards into an angle shape as viewed from the front-rear direction, are provided on both front and rear portions of the upper end portion 56b1 (an end portion facing the key top 52) of the second box-shaped portion 56b. In the six first projections 56b2, three first projections 56b2 are provided at substantially equal intervals on the front portion, and three first projections 56b2 are provided at substantially equal intervals on the rear portion of the upper end portion 56b1. In other words, the three first projections 56b2 on the front portion and the three first projections 56b2 on the rear portion are provided opposite to each other across a pushing axis A2 of the rubber key 56. The pushing axis A2 is along with the Z-axis and passes through a center of the rubber key 56 in the X-Y plane. A base of the second box-shaped portion 56b is made into a support surface 56b3 for supporting the key guide 54. An opening is provided individually in both front and rear sides of the support surface 56b3. These openings are opened one size larger than an outer circumference of each plate-shaped projecting portion 54b of the key guide 54 and are each made into a passage opening 56b4 through which the corresponding plate-shaped projecting portion 54b is passed in the up-down direction.

A circular recessed portion 56b5, which is recessed substantially into a circular shape, is provided at a substantially central portion of an upper surface of the support surface 56b3. The circular recessed portion 56b5 is provided one size larger than an outer circumference of the guide-side projecting portion 54d of the key guide 54, so that the guide-side projecting portion 54d fits in the circular recessed portion 56b5. A depth dimension of the circular recessed portion 56b5 is made substantially equal to a projecting dimension of the guide-side projecting portion 54d. On the other hand, a rubber-side projecting portion (a first pressing projecting portion) 56e, which projects downwards into a substantially circular cylindrical shape, is provided at a substantially central portion on a lower surface of the support surface 56b3. That is, the rubber-side projecting portion 56e is provided on the pushing axis A2 of the rubber key 56. The rubber-side projecting portion 56e is provided one size smaller than the outer circumference of the guide-side projection portion 54d of the key guide 54. The rubber-side projecting portion 56e presses on the moving contact module 62b of the button unit 62 provided on the circuit board 60 as a result of a push operation being performed on the push surface 52a1 of the key top 52.

The second protruding portion 56c is brought into abutment with the upper surface 60a of the circuit board 60 on a lower surface 56c2 thereof. As shown in FIG. 6B, three minute second projections 56c3, which each project upwards into an angle shape as viewed from the front-rear direction, are provided on both front and rear portions of an upper surface 56c1 of the second protruding portion 56c. In the three second projections 56c3, two second projections 56c3 are provided on the front portion, and one second projection 56c3 is provided on the rear portion. A first cut-out 56c4, which is cut out into a substantially rectangular shape, is provided in a substantially central portion in the front-rear direction on each of left and right portions of the second protruding portion 56c. Each cut-out 56c4 is cut out accordingly along a lower edge portion of the first angular cylindrical portion 56a.

A substantially circular passage hole 56c5, through which a restriction pin 58e of the light guide 58, which will be described later, is provided in a substantially central portion in the left-right direction of the front portion of the second protruding portion 56c. A circuit board-side cut-out 60d, which is formed by cutting out a part of a front end portion of the circuit board 60, is provided in a position on the circuit board 60 which corresponds to the passage hole 56c5 in the up-down direction (refer to FIG. 4). Three fixing pins 56f, which each project downwards in the form of a pin, are provided on the lower surface 56c2 of the second protruding portion 56c. The three fixing pins 56f are provided individually in three corner portions in four corners of the lower surface 56c2. On the other hand, attachment holes 60c, through which the fixing pins 56f are configured to be passed individually for attachment, are provided in the circuit board 60 in positions which correspond individually to the fixing pins 56f in the up-down direction (refer to FIG. 4).

As shown in FIG. 4, the light guide 58 of the decision button 50 is a member of a substantially angular cylindrical shape. The light guide 58 is formed one size larger than the rubber key 56 and has a light transmission property. The light guide 58 is formed from, for example, a polycarbonate. The light guide 58 has a second angular cylindrical portion 58a of a substantially angular cylindrical shape, an annular portion of a substantially angular ring shape (a surrounding portion) which protrudes upwards from an upper end portion of the second angular cylindrical portion 58a, and a third protruding portion 58c which protrudes outwards in the form of a collar from a lower end edge portion of the second angular cylindrical portion 58a. Four corners of the second angular cylindrical portion 58a are each formed into an angularly rounded shape. An opening dimension of the annular portion 58b is made slightly larger than a width dimension of the square plate portion 52a of the key top 52. An upper end edge portion of the annular portion 58b is embossed along a full circumference thereof.

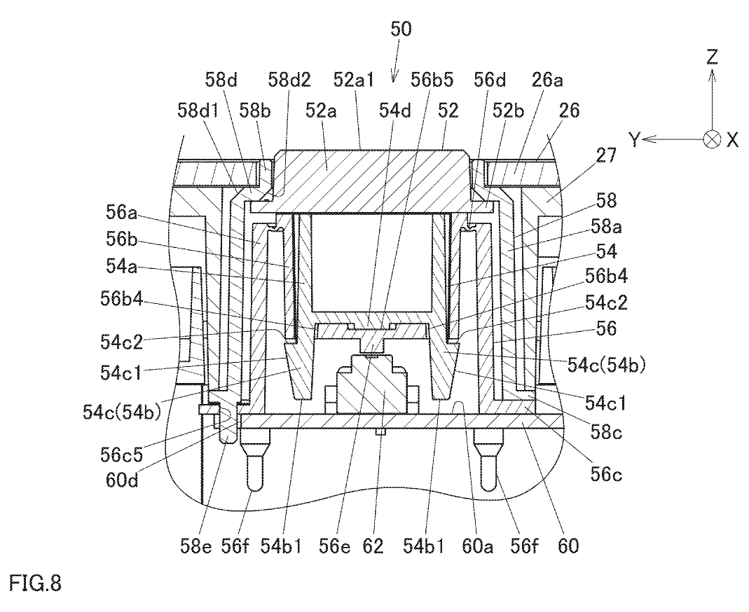

As shown in FIGS. 7 and 8, an inclined portion 58d, which inclines upwardly and inwardly, is provided at a boundary portion between the second angular cylindrical portion 58a and the annular portion 58b. An opening diameter of the light guide 58 is slightly narrowed from the second angular cylindrical portion 58a to the annular portion 58b by the inclined portion 58d so provided. A surface of the inclined portion 58d which is directed outwards of the light guide 58 constitutes a first reflection surface 58d1, and a surface of the light guide 58 which is directed inwards of the light guide 58 constitutes a second reflection surface 58d2. Inclined angles (acute angles) of the first reflection surface 58d1 and the second reflection surface 58d2 with respect to an axis direction of the second angular cylindrical portion 58a are 45 degrees. The axis direction of the second angular cylindrical portion 58a is along with the Z-axis and passes through a center of the light guide 58 in the X-Y plane.

A mirror finishing is applied to respective front surfaces of both the first reflection surface 58d1 and the second reflection surface 58d2.

The third protruding portion 58c is disposed on the second protruding portion 56c of the rubber key 56. A second cut-out 58c1, which is cut out into a substantially rectangular shape, is provided in a substantially central portion in the front-rear direction of each of left and right portions of the third protruding portion 58c. A restriction pin 58e, which projects downwards into a pin shape, is provided at a substantially central portion in the left-right direction of a lower surface of the front portion of the third protruding portion 58c (refer to FIGS. 4 and 8). The restriction pin 58e is passed through the passage hole 56c5 of the rubber key 56 so to fit in the circuit board-side cut-out 60dof the circuit board 60, whereby a movement of the light guide 58 in the left-right direction is restricted.

Next, referring to FIGS. 7 and 8, an assembling form of the individual members making up the decision button 50 will be described. The key guide 54 is placed in the rubber key 56 by the pair of plate-shaped projecting portions 54d being passed through the corresponding passage openings 564b of the rubber key 56 from above. The pair of plate-shaped projecting portions 54b are passed through the passage openings 564b to such an extent that the lower surface 54a2 of the first box-shaped portion 54a comes into abutment with an upper side of the support surface 56b3 of the rubber key 56. Here, when the individual dislocation prevention portions 54c of the key guide 54 pass through the corresponding passage openings 56b4, an inner surface of the second box-shaped portion 56b of the rubber key 56 is pressed on by the respective inclined surfaces 54c1 of the dislocation prevention portions 54c, whereby the inner surface of the second box-shaped portion 56b is elastically deformed outwards. Then, when the individual dislocation prevention portions 54c are passed through the corresponding passage openings 56b4, the inner surface of the second box-shaped portion 56b of the rubber key 56 is elastically restored, whereby the respective dislocation prevention surfaces 54c2 of the dislocation prevention portions 54c face the lower surface of the second box-shaped portion 56b of the rubber key 56.

The key guide 54 is supported in place inside the rubber key 56 by the pair of plate-shaped projecting portions 54b being passed through the corresponding passage openings 56b4, and the guide-side projecting portion 54d fits in the circular recessed portion 56b5 of the rubber key 56, whereby a distal end portion of the guide-side projecting portion 54d is brought into abutment with a base of the circular recessed portion 56b5. As a result, the key guide 54 is assembled in the rubber key 56. In this state, the pushing axis A1 of the key guide 54 and the pushing axis A2 of the rubber key 56 substantially coincide with each other, and a position of an upper end portion of the first box-shaped portion 54a of the key guide 54 in the up-down direction and a position of the upper end portion 56b1 of the second box-shaped portion 56b of the rubber key 56 in the up-down direction substantially coincide with each other. As a result, the first projecting portions 56b2 (not shown in FIGS. 7 and 8) of the rubber key 56 are being left projecting further upwards than an upper end of the first box-shaped portion 54a. In addition, in this state, the respective dislocation prevention surfaces 54c2 of the dislocation prevention portions 54c face a lower surface of the second box-shaped portion 56b, which is the lower surface of the support surface 56b3, of the rubber key 56 closely, whereby the plate-shaped projecting portions 54b of the key guide 54 are prevented from being dislocated from the corresponding passage openings 56b4 of the second box shaped portion 56b of the rubber key 56.

The rubber key 56, to which the key guide 54 is now assembled, is attached onto the circuit board 60. Specifically speaking, the three fixing pins 56f provided on the rubber key 56 are individually inserted into the three corresponding attachment holes 60c, which are provided in a front portion of the circuit board 60, whereby the rubber key 56 is attached onto the circuit board 60. The rubber key 56 is restricted from being moved along the plate surface of the circuit board 60 as a result of the rubber key 56 being attached onto the circuit board 60 in such a way. Then, a distal end portion (a lower surface) of the rubber-side projecting portion 56e of the rubber key 56 is being positioned above the button unit 62 provided on the front portion of the circuit board 60 closely. The two LEDs 64 provided at the front portion of the circuit board 60 are individually being positioned inside the corresponding first cut-outs 56c4 of the rubber key 56, whereby light emitting sides of the LEDs 64 are exposed upwards of the rubber key 56.

The key top 52 is placed on the rubber key 56 in such a state that the rubber key 56 is attached onto the circuit board 60. That is, the key top 52 is brought into abutment with distal end portions of the first projections 56b2 provided on the rubber key 56 on a lower surface thereof. In this way, since the key top 52 is placed only above the rubber key 56 with a slight gap defined between the key guide 54 and itself, for example, in the case that sounds are outputted from the electronic keyboard instrument 1, vibrations associated with the sounds so outputted are absorbed by the rubber key 56 having an elastic force, whereby the resonance of the key top 52 is prevented or suppressed. Projecting heights of the individual first projections 56b2 can be adjusted in accordance with an assemblage tolerance of the individual members making up the decision button 50 so that the push surface 52a1 of the key top 52 which is placed on the first projections 56b2 becomes level (or follows a panel surface of the upper panel 26a).

The light guide 58 is assembled in such a manner as to cover the rubber key 56 attached onto the circuit board 60. Specifically speaking, the light guide 58 is assembled in place over the rubber key 56 as a result of the restriction pin 58e provided on the light guide 58 being passed through the passage opening 56c5 of the rubber key 56 so as to fit in the circuit board-side cut-out 60d of the circuit board 60. The light guide 58 so assembled is restricted from moving in the left-right direction but is permitted to move in the front-rear direction while resisting the elastic force of the rubber key 56. In other words, the light guide 58 is held on the rubber key 56 in such a manner as to move in the front-rear direction along the push surface 52a1. In this state, the second angular cylindrical portion 58a of the light guide 58 surrounds the first angular cylindrical portion 56a of the rubber key 56 in such a state that a gap is defined between the first angular cylindrical portion 56a of the rubber key 56 and itself. Then, the annular portion 58b of the light guide 58 surrounds the square plate portion 52a in such a state that an inner surface thereof is in abutment with (or close to) the square plate portion 52a. The push surface 52a1 of the key top 52 is exposed upwards.

In addition, as a result of the light guide 58 being assembled in the way described above, the lower surface of the inclined portion 58d of the light guide 58 is brought into abutment with the first protruding portion 52b of the key top 52. In other words, the first protruding portion 52b protrudes outwards of the annular portion 58b of the light guide 58 and is disposed on a lower side (a side facing the push direction) of the annular portion 58b. As a result, the key top 52 is prevented from being dislocated upwards of the light guide 58. The two LEDs 64 provided at the front portion of the circuit board 60 are individually positioned inside the corresponding second cut-outs 58c1 of the light guide 58 and are being superposed on a lower end of the second angular cylindrical portion 58a in the up-down direction. Due to this, light emitted from the two LEDs 62 provided at the front portion of the circuit board 60 is incident on the lower end of the second angular cylindrical portion 58a. Thus, the decision button 50 is assembled onto the circuit board 60 by following the procedure that has been described heretofore.

Then, the circuit board 60, onto which the decision button 50 (as well as the first setting button 30 and the second setting button 40) is now assembled, is attached to the inner frame 27 of the left case 26 by, for example, being fastened thereto with screws. As a result, the decision button 50 is fixedly held between the circuit board 60 and the upper panel 26a in such a state that an upper surface of the inclined portion 58d of the light guide 58 is brought into abutment with a lower surface of an opening end of the setting opening portion 26a2 of the left case 26, and that the push surface 52a1 and an upper edge portion of the annular portion 58b of the light guide 58 are exposed upwards from the setting opening portion 26a2. The annular portion 58b is interposed between the square plate portion 52a of the key top 52 and the upper panel 26a of the left case 26. In addition, the third protruding portion 58c of the light guide 58 is held between the second protruding portion 56c of the rubber key 56 and the inner frame 27.

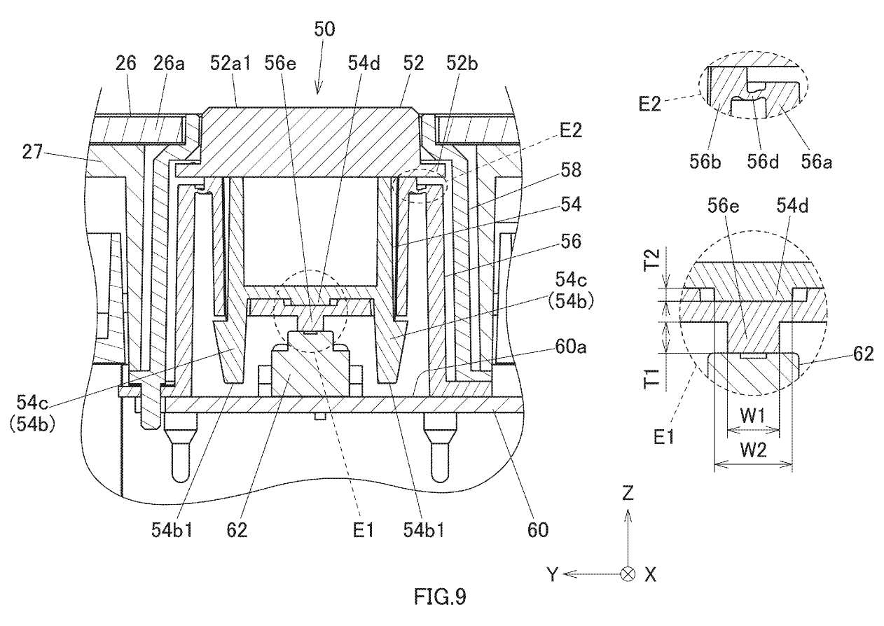

Next, referring to FIGS. 8 to 10, a function of the decision button 50 when the user pushes down the push surface 52a1 of the decision button 50 will be described below. As shown in FIG. 8, in the normal state, the rubber-side projecting portion 56e of the rubber key 56 is spaced apart from the button unit 62 in such a state that a slight gap is defined between and the button unit 62 and itself. Additionally, the abutment portions 54b1 of the key guide 54 are spaced apart from the upper surface 60a of the circuit board 60. As shown in an enlarged sectional view E1 in FIG. 9, in the normal state, a thickness dimension T1 of the rubber-side projecting portion 56e of the rubber key 56 is set larger than a thickness dimension T2 of the guide-side projecting portion 54d of the key guide 54, and a width dimension W1 of the rubber-side projecting portion 56e is set smaller than a width dimension W2 of the guide-side projecting portion 54d.

As shown in FIG. 9, when the push surface 52a1 is pushed down halfway from the normal state, a distal end portion of the rubber-side projecting portion 56e is brought into abutment with the button unit 62 (hereinafter, the state shown in FIG. 9 will be referred to as a “first push state”). In sifting from the normal state to the first push state, the first protruding portion 52b of the key top 52 moves away from the inclined portion 58d of the light guide 58 as a result of the push surface 52a1 being pushed down, whereby the rubber key 56 is pushed downwards by the key top 52. As a result, the hinge portion 56d, which is provided on the side of the rubber key 56 which faces the key top 52, is elastically deformed (refer to an enlarged sectional view E2 in FIG. 9), and the lower surface of the key top 52 is brought into abutment with an upper end of the key guide 54, whereby not only the rubber key 56 but also the key guide 54 is pushed downwards by the key top 52 to move accordingly. As a result of the key guide 54 moving downwards, the individual plate-shaped projecting portions 54b of the key guide 54 move towards the circuit board 60, and the rubber-side projecting portion 56e is pushed downwards by the guide-side projecting portion 54d so as to be brought into abutment with the button unit 62.

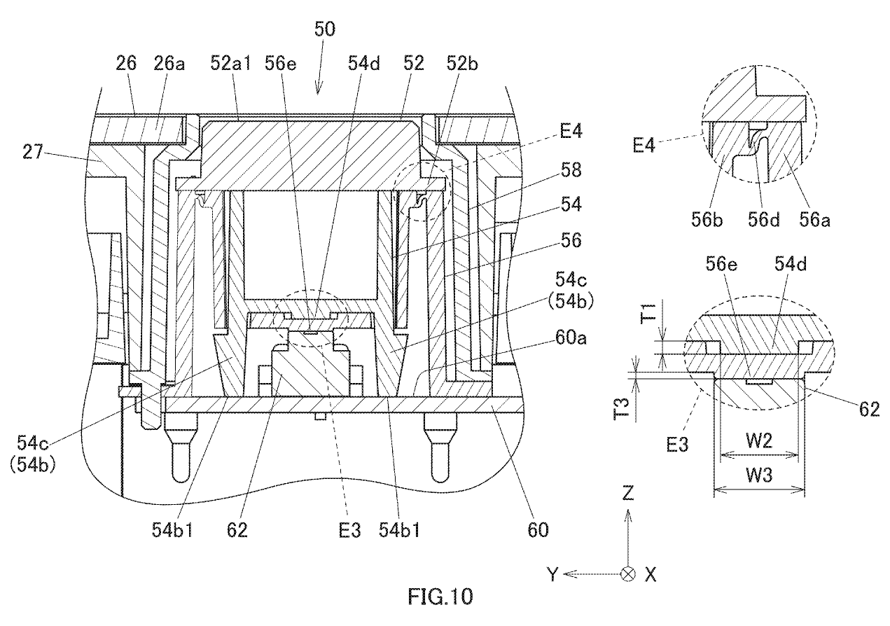

As shown in FIG. 10, when the push surface 52a1 is pushed down further from the first push state, the rubber key 56 is pushed downwards further by the key top 52, whereby the hinge portion 56d is elastically deformed further to flex downwards (refer to an enlarged sectional view E4 in FIG. 10). Then, the abutment portions 54b1 of the key guide 54 are brought into abutment with the circuit board 60, and the lower surface of the key top 52 is brought into abutment with the upper end of the first angular cylindrical portion 56a of the rubber key 56, resulting in a lower limit state in which the push surface 52a1 cannot be pushed down any further (hereinafter, the state shown in FIG. 10 will be referred to as a “second push state”). In the second push state, the push surface 52a1 is positioned lower than the panel surface of the upper panel 26a.

In sifting from the first push state to the second push state, the rubber-side projecting portion 56e, which is provided on the side of the rubber key 56 which faces the button unit 62, is pressed downwards further from an upper side (a side opposite to the side facing the button unit 62) by the guide-side projecting portion 54d, whereby the rubber-side projecting portion 56e presses downwards the moving contact module 62b of the button unit 62 while being compressed (elastically deformed) in the up-down direction between the guide-side projecting portion 54d and the button unit 62. The function of the decision button 50 is switched on and off as a result of the moving contact module 62b being pressed downwards by the rubber-side projecting portion 56e. When the push surface 52a1 is pushed down in the way described above, the rubber-side projecting portion 56e is pushed down via the key guide 54, whereby the button unit 62 is pressed down. When the finger is released from the push surface 52a1 as the push operation is completed, the individual members making up the decision button 50 are restored to their original positions in the normal state by means of an elastic restoration force of the rubber-side projecting portion 56e.

Thus, as a result of the rubber-side projecting portion 56e being compressed in the way as has been described above, as shown in an enlarged sectional view E3 in FIG. 10, in the second push state, a thickness dimension T3 of the rubber-side projecting portion 56e so compressed becomes smaller than the thickness dimension T2 of the guide-side projecting portion 54d, and a width dimension W3 of the rubber-side projecting portion 56e so compressed becomes larger than the width dimension W2 of the guide-side projecting portion 54d. In this way, the pressing force by which the moving contact module 62b is pressed down by the rubber-side projecting portion 56e can be made optimum by adjusting the thickness dimensions and the width dimensions of the guide-side projecting portion 54d and the rubber-side projecting portion 56e in the normal state in accordance with a degree of a pressing force which is applied to the rubber-side projecting portion 56e when the rubber-side projecting portion 56e is pushed downwards (a degree of compression of the rubber-side projecting portion 56e), a moving distance of the key guide 54 when the rubber-side projecting portion 56e is pushed downwards, and the like.

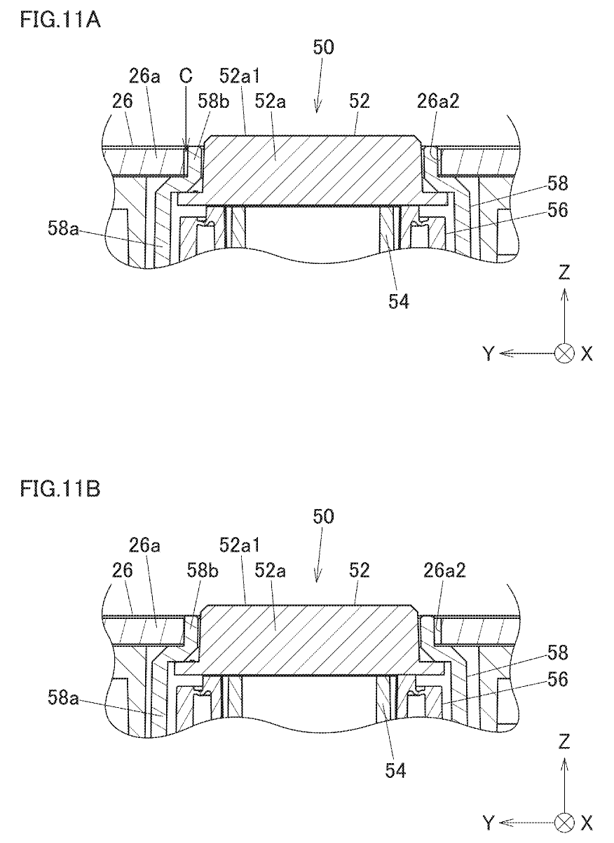

Here, there may be a case in which the upper panel 26a having provided therein the setting opening portion 26a2 from which the push surface 52a1 of the decision button 50 is exposed expands or contracts due to a temperature environment on the circumference of the electronic keyboard instrument 1. As show in FIG. 11A, in the case of the decision button 50 of the present embodiment, a gap is defined between the annular portion 58b of the light guide 58 and the upper panel 26a. As a result, as shown in FIG. 11B, even though the position of an opening end of the setting opening portion 26a2 deviates towards the rear due to an expansion of the upper panel 26a or the like, a risk of the light guide 58 being pushed by the upper panel 26a is prevented or suppressed. Additionally, since the light guide 58 is permitted to move in the front-rear direction as described above, even though the annular portion 58b is pushed by the upper panel 26a as a result of the opening end of the setting opening portion 26a2 being caused to deviate in position largely in the front-rear direction, the light guide 58 moves in the front-rear direction in the front-rear direction so as to absorb the positional deviation. In this way, the decision button 50 of the present embodiment is prevented or restrained from being affected by the expansion or contraction of the upper panel 26a.

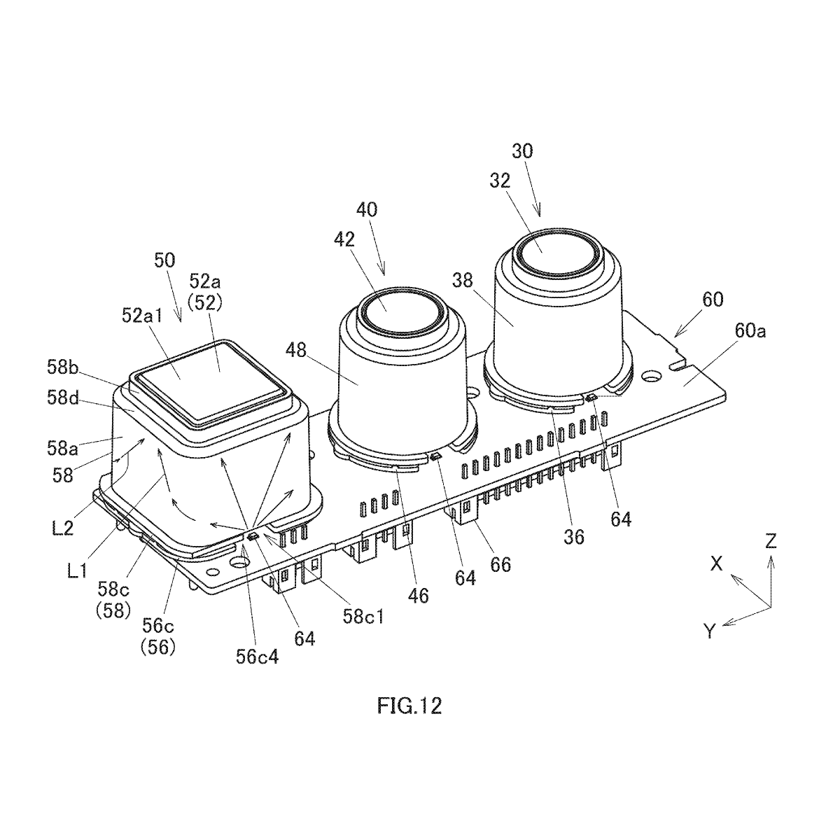

Next, referring to FIGS. 7 and 12, a light guiding mode will be described in which light emitted from the two LEDs 64 provided at the front portion of the circuit board 60 is guided. Lights (denoted individually by reference symbols L1, L2) emitted from the individual LEDs 64 enter the light guide 58 from the corresponding second cut-outs 58c1 of the light guide 58 so as to be incident on the lower end of the second angular cylindrical portion 58a. The lights L1, L2 which have entered the second angular cylindrical portion 58a are radially diffused upwards along the second angular cylindrical portion 58a by a light diffusing agent applied to the material and eventually arrive at the first reflection surface 58d1 of the inclined portion 58d.

Light axes of the individual lights L1, L2 which have now arrived at the first reflection surface 58d1 are turned inwards through 90 degrees (towards the second reflection surface 58d2) by the first reflection surface 58d1, and the lights L1, L2 so turned are then diffused while being reflected and eventually arrive at the second reflection surface 58d2. The light axes of the individual lights L1, L2 which have arrived at the second reflection surface 58d2 are turned upwards through 90 degrees (towards the annular portion 58b), and the lights L1, L2 so turned are then diffused while being reflected and are eventually emitted outwards of the upper panel 26a from the upper end of the annular portion 58b. Then, the user can see the lights L1, L2 emerging from the upper end of the annular portion 58b to the outside of the upper panel 26a.

Thus, as has been described heretofore, the decision button 50 of the present embodiment includes the key top 52 on which a push operation can be performed, the substantially cylindrical rubber key 56 which is provided on the side of the key top 52 which faces the push direction and which is configured to be elastically deformed on the side thereof which faces the key top 52 in response to the push operation which is performed on the key top 52, the button unit 62 configured to detect the push operation performed on the key top 52, and the key guide 54 which is supported by the rubber key 56 inside the rubber key 56 and which is configured to move in the push direction in response to the push operation performed on the key top 52. Then, the side of the rubber key 56 which faces the button unit 62 is elastically deformed as a result of the guide key 54 moving in response to the push operation.

In this way, with the decision button 50, when the user pushes down the key top 52, the key top 52 does not directly push down the rubber key 56, but the key guide 54 supported inside the rubber key 56 is pushed down to move in the push direction by the key top 52 while the side of the rubber key 56 which faces the key top 52 is being elastically deformed. Then, the side of the rubber key 56 which faces the button unit 62 is elastically deformed by the movement of the key guide 54, whereby the button unit 62 is pressed to thereby detect the push operation performed on the key top 52. As a result, a touching feel of the key guide 54 which is harder than the rubber key 56 is transmitted to the finger of the user when the user pushes down the key top 52, while the push operation is performed smoothly by the elastic deformation of the rubber key 56, and there is no such case that the elastic force of the rubber key 56 is transmitted directly to the finger. As a result, with the decision button 50 of the present embodiment, the user can sense a good clicking feel when the user touches the key top 52.

In addition, with the decision button 50 described above, the rubber key 56 has the rubber-side projecting portion 56e configured to press the button unit 62 in response to the bush-down operation performed on the key top 52, and the key guide 54 has the guide-side projecting portion 54d configured to press the rubber-side projecting portion 56e from the opposite side to the side facing the button unit 62 in response to the push operation performed on the key top 52. With this configuration, the button unit 62 can be pressed effectively by the rubber-side projecting portion 56e, and the rubber-side projecting portion 56e, which constitutes the part of the rubber key 56, can be elastically deformed in an effective fashion by the guide-side projecting portion 54d.

With the decision button 50 described above, the rubber-side projecting portion 56e and the guide-side projecting portion 54d have the substantially circular cylindrical shape, and in the normal state in which the rubber-side projecting portion 56e does not press the button unit 62, the thickness dimension T1 of the rubber-side projecting portion 56e is larger than the thickness dimension T2 of the guide-side projecting portion 54d, and the width dimension W1 of the rubber-side projecting portion 56e is smaller than the width dimension W2 of the guide-side projecting portion 54d. In this way, the thickness dimensions and the width dimensions of the guide-side projecting portion 54d and the rubber-side projecting portion 56e in the normal state can be adjusted in accordance with the degree of the pressing force by which the moving contact module 62b of the button unit 62 is to be pressed, the degree of hardness of the rubber key 56, the moving distance of the key guide 54 when the rubber-side projecting portion 56e is pushed downwards, and the like. As a result, the pressing force by which the rubber-side projecting portion 56e presses on the button unit 62 can be made optimum.

With the decision button 50 described above, the rubber-side projecting portion 56e is provided on the pushing axis A2 of the rubber key 56, and the guide-side projecting portion 54d is provided on the pushing axis A1 of the key guide 54, the pushing axis A2 of the rubber-side projecting portion 56e and the pushing axis A1 of the guide-side projecting portion 54d substantially coinciding with each other. According to this configuration, when the key guide 54 is pushed down via the key top 52, the push force then is transmitted substantially uniformly to the rubber-side projecting portion 56e and the guide-side projecting portion 54d. As a result, when the key top 52 is pushed down, the user can sense the good clicking feel.

In addition, with the decision button 50 described above, the first projections 56b2 are provided at the six locations on the side of the rubber key 56 which faces the key top 52 in such a manner that the first projections 56b2 project towards the key top 52 and the distal end portions thereof are brought into abutment with the key top 52, and the three first projections 56b2 and the other three first projections 56b2 are provided opposite to each other across the pushing axis A2 of the rubber key 56. With this configuration, the horizontal state or levelness of the key top 52 with which the distal end portions of the individual first projections 56b2 are brought into abutment can be adjusted by adjusting the projecting height of the first projections 562b in accordance with the assemblage tolerance of the individual members which make up the decision button 50. As a result, the clicking feel can be improved which the user would sense when he or she pushes down the key top 52.

With the decision button 50 described above, the decision button 50 includes the circuit board 60 on which the button unit 62 is provided, and the key guide 54 is supported by the rubber key 56 in such a state that the key guide 54 is left apart from the plate surface of the circuit board 60 and has the abutment portion 54b1 configured to be brought into abutment with the plate surface of the circuit board 60 in response to the push operation performed on the key top 52. With this configuration, since the key guide 54 is prevented from moving any further towards the circuit board 60 (towards the button unit 62) by the abutment of the abutment portion 54b1 with the plate surface of the circuit board 60, there is no such a case in which the push surface 52a1 is pushed down excessively. This can prevent a reduction in the elastic force of the rubber key 56 as well as the damage to the rubber-side projecting portion 56e, the guide-side projecting portion 54d, and the button unit 62 which would both be caused by the push surface 52a1 being pushed down excessively.

In addition, with the decision button 50 described above, the rubber key 56 has the first angular cylindrical portion 56a which is fixed to the plate surface of the circuit board 60, the second box-shaped portion 56b configured to support the key guide 54, and the hinge portion 56d which connects the first angular cylindrical portion 56a and the second box-shaped portion 56b together, and the second box-shaped portion 56b moves relatively to the first angular cylindrical portion 56a in the push direction as a result of the hinge portion 56d being elastically deformed in response to the push operation performed on the key top 52. This can realize the specific configuration for moving the second box-shaped portion 56b of the rubber key 56 towards the button unit 62 in such a state that the rubber key 56 is fixed to the plate surface of the circuit board 60.

With the decision button 50 described above, the key top 52 has the push surface 52a1 on which the push operation is performed, and the light guide 58 is provided which has the annular portion 58b which surrounds the circumference of the push surface 52a1 and which is configured to guide light emitted from the LEDs 64 towards the annular portion 58b. According to this configuration, light emitted from the LEDs 64 is guided towards the annular portion 58b by the light guide 58 and is then emitted to the outside of the decision button 50 from the circumference of the push surface 52a1. As a result, the user can see the light from the LEDs 64 emerging from the circumference of the push surface 52a1, thereby making it possible to improve the visual effect and visibility of the decision button 50.

With the decision button 50 described above, the light guide 58 is held on the rubber key 56 in such a manner as to be permitted to move in at least one direction along the push surface 52a1. According to this configuration, even in the event that the light guide 58 is pushed by the member which surrounds the decision button 50, for example, as a result of a positional deviation of that member, the positional deviation of the member is absorbed by the movement of the light guide 58 in the direction along the push surface 52a1. As a result, it becomes possible to prevent or restrain the members making up the decision button 50 from being affected by the positional deviation of the member which surrounds the circumference of the decision button 50.

With the decision button 50 described above, the key top 52 has the first protruding portion 52b which protrudes to the outside of the push surface 52a1 and which is provided on the side of the annular portion 58b of the light guide 58 where the annular portion 58b is pushed down. With this configuration, in the case that the key top 52 moves to an opposite side to the push direction, the first protruding portion 52b interferes with the annular portion 58b of the light guide 58. This can prevent the key top 52 from being dislocated to the opposite side to the push direction for removal from the decision button 50.

Additionally, with the decision button 50 described above, the key top 52 comes into abutment with only the rubber key 56 in the push direction. With this configuration, in the normal state, the top key 52 comes into abutment with only the upper end of the rubber key 56 and is not placed on the key guide 54. As a result, in the case that sounds are outputted from, for example, the electronic keyboard instrument 1, vibrations associated with the sounds are absorbed by the rubber key 56 having the elastic force. As a result, the generation of resonance in the key top 52 can be prevented or restrained.

While in the buttons 30, 40, 50 which make up the button group SG, the decision button 50 is taken as the example for the description of the present embodiment, the same function and advantage as those of the decision button 50 can also be provided for the other first setting button 30 and second setting button 40.

In addition, the electronic keyboard instrument 1 of the present embodiment includes the decision button 50. As a result, the electronic keyboard instrument 1 can be realized in which the user can push down the decision button 50 while sensing the good clicking feel.

The electronic keyboard instrument 1 includes the LEDs 64 which emit light towards the key top 52. With this configuration, since light from the LEDs 64 is emitted to the outside of the electronic keyboard instrument 1 from the circumference of the key top 52, the dramatic effect of the electronic keyboard instrument 1 can be enhanced.

While the button apparatus is applied to switching on and off the function thereof in the present embodiment, the present embodiment is not limited thereto, and hence, a configuration may be adopted in which the button apparatus also includes a function as, for example, a rotary knob for volume control.

While the electronic keyboard instrument 1 is taken as an example of electronic equipment in the present embodiment, the present embodiment is not limited thereto, and hence, the present embodiment can also be applied to a personal computer, a printer, an electronic calculator, an electronic dictionary, a personal digital assistant (PDA) display device, a wristwatch, household electronic equipment such as a desk-top or table-top clock, and in-office electronic equipment.

The embodiment that has been described heretofore is presented as the example, and hence, there is no intention to limit the scope of the present invention by the embodiment. The novel embodiment can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents.

What is claimed is:

1. A switch apparatus comprising:
a switch member including a main body on which a switch operation can be performed and a protruding portion which protrudes outwards from a side edge portion of the main body;
a light source; and
a light guide surrounding the switch member;
wherein the light guide includes a first surface on which light from the light source is incident, a second surface which emits the light through an interior of the light guide and a third surface which covers at least part of the protruding portion.

2. The switch apparatus according to claim 1,
wherein the third surface of the light guide restricts the movement of the switch member in response to the switch operation.

3. The switch apparatus according to claim 1,
wherein the switch operation includes a first operation which moves the switch member along a first direction and a second operation which moves the switch member along a second direction opposite to the first direction.

4. The switch apparatus according to claim 3,
wherein the length between the third surface and the at least part of the protruding portion resulting from the second operation is shorter than the length between the third surface and the at least part of the protruding portion resulting from the first operation.

5. The switch apparatus according to claim 1,
wherein the light guide includes a fourth surface which reflects light passing through the interior of the light guide.

6. The switch apparatus according to claim 5,
wherein the fourth surface is inclined to a surrounding surface of the fourth surface.

7. The switch apparatus according to claim 5,
wherein the light guide includes a fifth surface which reflects light reflected by the fourth surface.

8. The switch apparatus according to claim 7,
wherein the fifth surface is inclined to a surrounding surface of the fifth surface.

9. The switch apparatus according to claim 7,
wherein the fourth surface is positioned opposite the fifth surface,
wherein the third surface is positioned between the fourth surface and the fifth surface.

10. The switch apparatus according to claim 1,
wherein the light source including a plurality of light emitter which face each other via the switch member in top view.

11. The switch apparatus according to claim 1, further comprising:
a circuit board;
wherein light guide including a restriction protrusion corresponding to the circuit board such that the light guide is restricted from moving in a side direction.

12. The switch apparatus according to claim 1, further comprising:
a case including a hole which exposes switch member and the second surface of the light guide.

13. The switch apparatus according to claim 1, further comprising:
an elastic member provided on a first direction side of the switch member and configured to be elastically deformed on a side thereof which contacts a lower surface of the protruding portion in response to the switch operation performed on the switch member.

14. The switch apparatus according to claim 1, further comprising:
an elastic member of a substantially hollowed shape provided on a first direction side of the switch member and configured to be elastically deformed on a side thereof which faces the switch member in response to the switch operation performed on the switch member;
a detector configured to detect the switch operation performed on the switch member;
a moving member supported on the elastic member and configured to move in the first direction in response to the switch operation performed on the switch member; and
a circuit board on which the detector is provided, wherein a side of the elastic member which faces the detector is elastically deformed as a result of the moving member moving in response to the switch operation, and
wherein the moving member is supported on the elastic member in such a manner as to be spaced apart from a plate surf ace of the circuit board in a state in which the switch operation is not performed on the switch member and comprises an abutment portion configured to be brought into abutment with the plate surface of the circuit board in response to the switch operation performed on the switch member.

15. The switch apparatus according to claim 13,
wherein the light guide surrounding the elastic member, the detector, and the moving member.

16. Electronic equipment comprising:
the switch apparatus according to claim 1; and
an electronic equipment main body configured to be driven by an operation at the switch apparatus.
